(19) United States
(12) Patent Application Publication
(10) Pub. No.: US 2001/0050686 A1
(43) Pub. Date: Dec. 13, 2001

(54) Autostereoscopic display driver

(75) Inventor: Richard J. Allen, Redhill (GB)

Correspondence Address: Jack E. Haken, Corporate Patent Counsel, U.S. Philips Corporation, 580 White Plains Road, Tarrytown, NY, 10591, US

(73) Assignee: U.S. Philips Corporation

(21) Appl. No.: 09/772,004

(22) Filed: Jan. 29, 2001

(30) Foreign Application Priority Data
Feb. 15, 2000 (GB) 0003311.8

(51) Int. Cl. G06F 12/02; G09G 5/00

(52) U.S. Cl. 345/543

(57) ABSTRACT

An apparatus is disclosed for controlling pixel addressing of a pixel display device to drive the display device as an N view autostereoscopic display. A graphics controller (40) generates multiple views of a scene from different viewpoints. The graphics controller (40) selectively accesses a combined image memory buffer (43), so that portions of each view are written by the graphics controller (40) to allocated areas of the combined image memory buffer (43). A display (54) is driven according to the data in the combined memory buffer. This arrangement reduced data transfer volume for the generation of image data which comprises interleaved portions from individual images.

The present invention relates to the driving of pixel display devices, and in particular the generation of interlaced images for supply to autostereoscopic display devices. Such display devices typically comprise an array of display pixels arranged in rows and columns, and an array of elongate lenticular elements extending parallel to one another overlying the display pixel array and through which the display pixels are viewed.

Examples of such autostereoscopic display apparatus are described in the paper entitled “3-D Displays for Video telephone Applications” by D. Sheat et al in Eurodisplay 1993 and in GB-A-2196166. In these apparatuses, the display is produced by a matrix display device comprising a matrix LC (liquid crystal) display panel having a row and column array of display elements and acting as a spatial light modulator. The lenticular elements are provided by a lenticular sheet, whose lenticles, comprising (semi) cylindrical lens elements, extend in the column direction of the display panel with each lenticle overlying a respective group of two, or more, adjacent columns of display elements and extending parallel with the display element columns. Commonly in such apparatus, the LC matrix display panel is of a conventional form, comprising regularly spaced rows and columns of display elements, as used in other types of display applications, e.g. computer display screens, although other arrangements may be provided.

In an arrangement in which each lenticle is associated with two columns of display elements, the display elements in each column provide a vertical slice of a respective 2D (sub-)image. The lenticular sheet directs these two slices and corresponding slices from the display element columns associated with the other lenticles, to the left and right eyes respectively of a viewer in front of the sheet so that the viewer perceives a single stereoscopic image. In other, multiple view, arrangements, each lenticle is associated with a group of four, or more, adjacent display elements in the row direction. Corresponding columns of display elements in each group are arranged appropriately to provide a vertical slice from a respective 2-D (sub-) image so that as a viewer moves his or her head a series of successive, different, stereoscopic views are perceived creating, for example, a look-around impression.

The invention is concerned particularly with multiple view systems. The generation of an image for display by this type of system requires data to be extracted from the number of views of the scene and to be combined. Conventionally, a graphics card generates the multiple views, for example from a 3D model of the scene, and these views are then each stored in an associated memory buffer within a video card. In order to combine pixels from the multiple views, a processor reads and processes the data from the memory buffers, and then stores the combined view for display in a further memory buffer within the video card. This process requires transfer of large quantities of data between the video card (having the memory buffers), and the processor, and requires transfer of data in both directions. The bandwidth of the interface between the processor and the graphics card limits the speed at which this data transfer can take place, and the combination of multiple views can dramatically reduce the system speed, and the rendering of moving images may not be possible.

According to the present invention, there is provided an apparatus for controlling pixel addressing of a pixel display device to drive the display device as an N view autostereoscopic display, the apparatus comprising:

a graphics controller which a generates multiple views of a scene from different viewpoints, the graphics controller comprising means for selectively accessing a combined image memory buffer, wherein each view is associated with a memory buffer access pattern, such that portions of each view are written by the graphics controller to allocated areas of the combined image memory buffer; and

a display driver for driving the display according to the data in the combined memory buffer.

The invention provides a pixel addressing circuit in which the graphics controller performs the operation of combining multiple views into a single image for display using, for example, a lenticular screen autosterioscopic display. This reduces the required data transfer along interfaces within the system. Essentially, data is written to the combined image memory buffer using masked memory access, so that as a view from one viewpoint is created by the graphics controller, only the parts of the image which are required for the combined autosterioscopic display image are stored in the shared memory buffer.

The combined image memory buffer may be part of a video card or else it may be part of a graphics card having the graphics controller.

The graphics controller preferably further comprises one or more depth buffers.

The masking operation, by which portions of each view are written by the graphics controller to allocated areas of the combined image memory buffer, is preferably controlled using switched access to the memory locations. Thus, the memory buffer preferably comprises row and column decoders, the decoder settings defining the areas of the memory buffer to which access is provided. Each view has an associated memory access pattern.

Embodiments of an autostereoscopic display apparatus driven using pixel addressing apparatus in accordance with the invention will now be described, by way of example, with reference to the accompanying drawings, in which:

FIG. 1 is a schematic perspective view of an embodiment of autostereoscopic display apparatus;

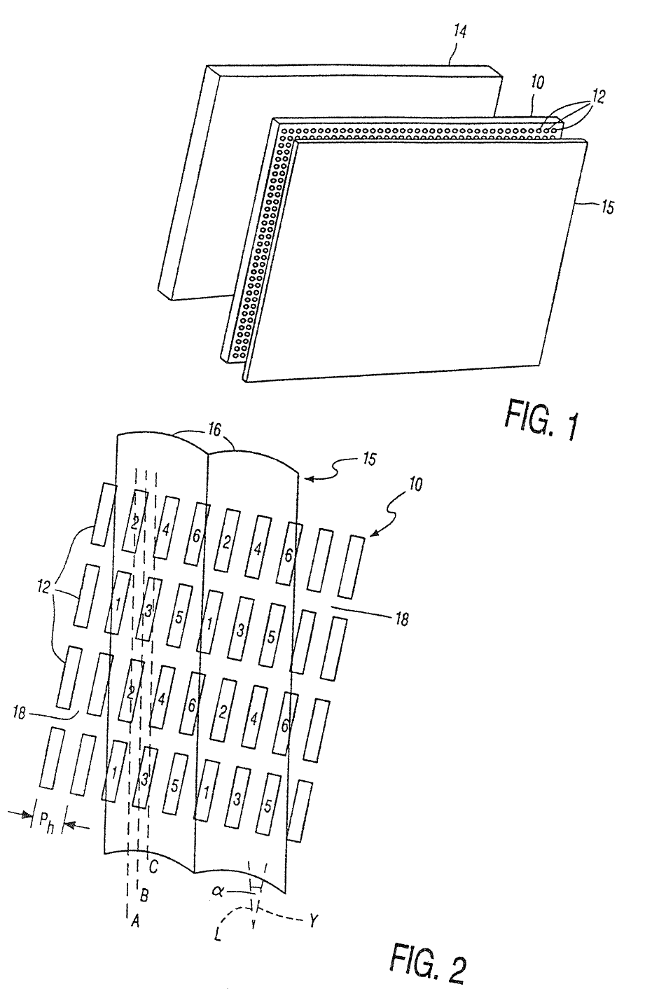

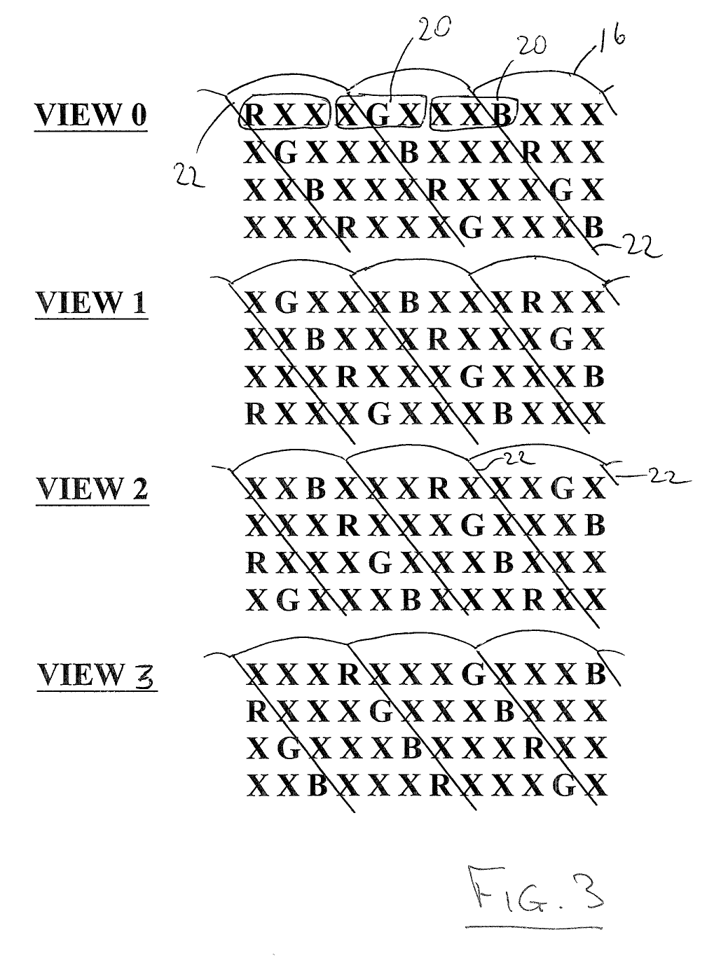

FIG. 2 is a schematic plan view of a part of the display element array of the display panel of FIG. 1, providing a six view output;

FIG. 3 is a schematic diagram for explaining how multiple views may be combined;

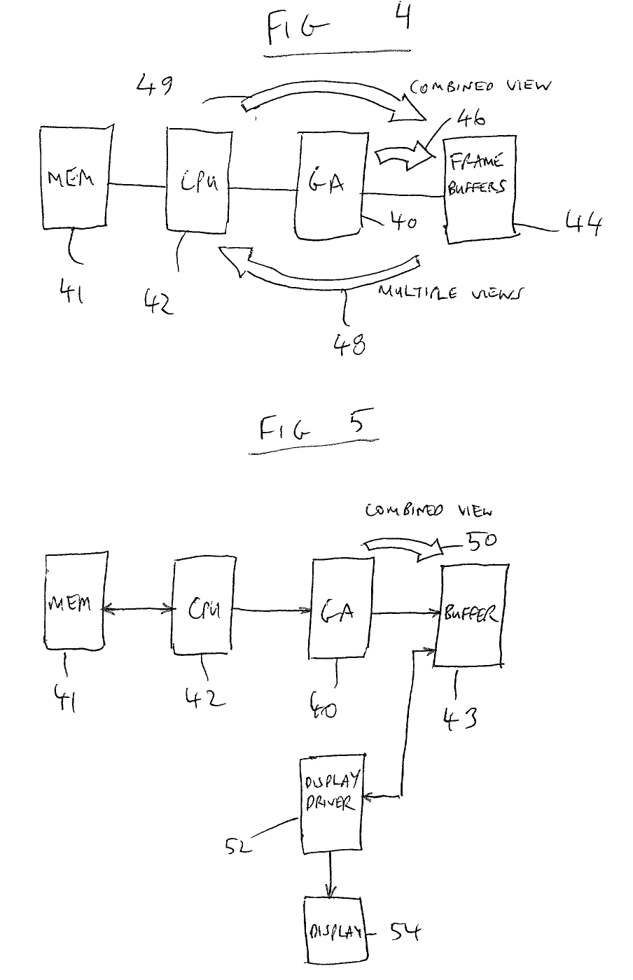

FIG. 4 is a schematic diagram for explaining a known hardware configuration for generating a combined image; and

FIG. 5 is a block schematic diagram illustrating components of a display driver apparatus embodying the invention.

In the following example, a direct-view type of 3D-LCD lenticular array display apparatus having a slanted arrangement of lenticulars will be initially described with reference to FIGS. 1 and 2, in order to illustrate a suitable host system for the present invention. A more detailed description of this apparatus, together with a number of modifications and variations thereto, is given in the commonly-assigned European patent application number EP-A-0791847 (published Aug. 27, 1997 with an earliest priority date of Feb. 23, 1996) the disclosure of which is herein incorporated by reference.

It will be understood that the Figures are merely schematic and are not drawn to scale. For clarity of illustration, certain dimensions may have been exaggerated whilst other dimensions may have been reduced. Also, where appropriate, the same reference numerals and letters are used throughout the Figures to indicate the same parts and dimensions.

Referring to FIG. 1, the display apparatus includes a conventional LC matrix display panel 10 used as a spatial light modulator and comprising a planar array of individually addressable and similarly sized display elements 12 arranged in aligned rows and columns perpendicularly to one another. Whilst only a few display elements are shown, there may in practice be around 800 columns (or 2400 columns if colour, with RGB triplets used to provide a full colour display) and 600 rows of display elements. Such panels are well known and will not be described here in detail.

The display elements 12 are substantially rectangular in shape and are regularly spaced from one another with the display elements in two adjacent columns being separated by a gap extending in the column (vertical) direction and with the display elements in two adjacent rows being separated by a gap extending in the row (horizontal) direction. The panel 10 is of the active matrix type in which each display element is associated with a switching element, comprising for, example, a TFT or a thin film diode, TFD, situated adjacent the display element.

The display panel 10 is illuminated by a light source 14 which, in this example, comprises a planar back-light extending over the area of the display element array. Light from the source 14 is directed through the panel with the individual display elements being driven, by appropriate application of drive voltages, to modulate this light in conventional manner to produce a display output. The array of display-pixels constituting the display produced thus corresponds with the display element array, each display element providing a respective display pixel.

Over the output side of the panel 10, opposite that facing the light source, there is disposed a lenticular sheet 15 comprising an array of elongate, parallel, lenticles, or lens elements, acting as optical director means to provide separate images to a viewer's eyes, producing a stereoscopic display to a viewer facing the side of the sheet 15 remote from the panel 10. The lenticles 16 of the sheet 15, which is of conventional form, comprise optically cylindrically converging lenticles, for example formed as convex cylindrical lenses or graded refractive index cylindrical lenses. Autostereoscopic display apparatus using such lenticular sheets in conjunction with matrix display panels are well known in the art. The lenticles in the apparatus of FIG. 1 are arranged slanted with respect to the columns of display pixels, that is, their main longitudinal axis is at an angle to the column direction of the display element array. This arrangement has been found to provide a number of benefits in terms of reduced resolution loss and enhanced masking of the black area between display elements, as is described in the above-referenced application number EP-A-0791 847.

The pitch of the lenticles is chosen in relation to the pitch of the display elements in the horizontal direction according to the number of views required, as will be described. Each lenticle, apart from those at the sides of the display element array, extends from top to bottom of the display element array. FIG. 2 illustrates an example arrangement of the lenticles in combination with the display panel for a typical part of the display panel. The longitudinal axis of the lenticles, L, is slanted at an angle α to the column direction. In this example, the spacing between the longitudinal axes of the parallel lenticles is of such a width with respect to the pitch of the display elements in a row, and slanted at such an angle with respect to the columns of display elements, as to provide a six view system. The display elements 12 are numbered (1 to 6) according to the view-number to which they belong. The individual, and substantially identical, lenticles 16 of the lenticular sheet 15 each have a width which corresponds approximately to three adjacent display elements in a row, i.e. the width of three display elements and three intervening gaps. Display elements of the six views are thus situated in groups comprising display elements from two adjacent rows, with three elements in each row.

The individually operable display elements are driven by the application of display information in such a manner that a narrow slice of a 2D image is displayed by selected display elements under a lenticle. The display produced by the panel comprises six interleaved 2D sub-images constituted by the outputs from respective display elements. Each lenticle 16 provides six output beams from the underlying display elements with view-numbers 1 to 6 respectively whose optical axes are in mutually different directions and angularly spread around the longitudinal axis of the lenticle. With the appropriate 2D image information applied to the display elements and with a viewer's eyes being at the appropriate distance to receive different ones of the output beams then a 3D image is perceived. As the viewer's head moves in the horizontal (row) direction then a number of stereoscopic images can be viewed in succession. Thus, a viewer's two eyes would see respectively, for example, an image composed of all display elements “1” and an image composed of all display elements “2”. As the viewer's head moves, images comprised of all display elements “3” and all display elements “4” will be seen by respective eyes, then images comprised of all display elements “3” and all display elements “5”, and so on. At another viewing distance, closer to the panel, the viewer may, for example, see views “1” and “2” together with one eye and views “3” and “4” together with the other eye.

The plane of the display elements 12 coincides with the focal plane of the lenticles 16, the lenticles being suitably designed and spaced for this purpose, and consequently position within the display element plane corresponds to viewing angle. Hence all points on the dashed line A in FIG. 2 are seen simultaneously by a viewer under one specific horizontal (row direction) viewing angle as are all points on the dashed line B in FIG. 2 from a different viewing angle. Line A represents a (monocular) viewing position in which only display elements from view “2” can be seen. Line B represents a (monocular) viewing position in which display elements from both view “2” and view “3” can be seen together. Line C in turn represents a position in which only display elements from view “3” can be seen. Thus, as the viewer's head moves, with one eye closed, from the position corresponding to line A to line B and then line C a gradual change-over from view “2” to view “3” is experienced.

The slanting lenticle arrangement can be applied to both monochrome and colour displays.

FIG. 3 shows how individual pixels may be driven in a four view colour scheme. For colour displays, three adjacent columns of pixels define colour triplets 20. Each triplet 20 has three pixels which are associated with red, green and blue colour filters respectively of a colour microfilter array. For a colour display, the vertical resolution is divided by three compared with a monochrome display. As explained with reference to FIG. 2, each view is associated with a particular position under each lenticular lens. The border between lenses is illustrated as 22 in FIG. 3.

As shown, each lens has a width corresponding to four columns, so that there are four possible pixel positions under each lens. All pixels of view 0 to be displayed occupy the first position from the left. All pixels of view 1 to be displayed occupy the second position from the left, and so on.

The image to be provided to the display comprises the addition of the four views shown in FIG. 3. Thus, portions from each view are provided to allocated areas of the eventual display.

FIG. 3 shows a simple pixel arrangement for (only) four views and with the lenticle spacing being an integer of the column spacing. Various other schemes are possible. For example, it is also possible to arrange the lenticle spacing to correspond to a non-integer number of pixels, and it has been recognised that this approach may provide an improved balance between resulting horizontal and vertical resolution, by offsetting the views under each lenticle between rows. The Figures show lenticles arranged at an angle to the vertical, although this is also not essential.

FIG. 4 shows a known system for combining data from multiple views, for example to implement the pattern of FIG. 3. A graphics accelerator 40 generates (i.e. renders) the multiple views, for example from a 3D model of the scene stored in the memory 41 associated with the processor 42. The multiple views are rendered in turn, and are then each stored in an associated video memory buffer 44, for example within a video card. This is illustrated as arrow 46. Each video buffer stores image as well as depth information, and for this purpose separate image and depth buffers may be provided.

In order to combine pixels from the multiple views, which are stored in full in allocated buffers, the processor 42 reads and processes the data from the memory buffers (arrow 48) and then sends the combined view for display to a further memory buffer (arrow 49). This may be performed on a pixel by pixel basis, or on a frame by frame basis. This process requires transfer of large quantities of data between the video card with the memory buffers, and the processor, and requires transfer of data in both directions. The bandwidth of the interfaces between the processor and the graphics card limits the speed at which this data transfer can take place, and the combination of multiple views can dramatically reduce the system speed performance.

A digital to analogue converter prepares the digital data stored in the combined image buffer for transmission to the display, and generates the sync pulses required by the display device.

FIG. 5 shows the system of the invention. The graphics accelerator 40 again generates multiple views of a scene from different viewpoints. A combined image memory buffer 43 is provided, and the graphics accelerator selectively accesses the memory buffer 43. Each view is associated with a memory buffer access pattern, and as the views are produced, portions of each view are written by the graphics accelerator to allocated areas of the combined image memory buffer 43, illustrated as arrow 50. Thus, each view is associated with a stencil derived from the pixel layout design. Thus, taking the example of FIG. 3, View 0 is associated with a stencil which allows data to be written to all memory locations associated with pixels in the left most position under the lenticles. View 3 is associated with a stencil which allows data to be written to all memory locations associated with pixels in the right most position under the lenticles.

The stencil layout for each image may be stored in the system memory 41 with the CPU 42 governing the operation of the graphics controller 40 using the appropriate stencil during rendering of the multiple views.

The combined image in the buffer 43 is again provided to a digital to analogue converter which is controlled to derive the display drive controls in known manner. This converter may form part of a display driver 52 for driving the display 54 (as shown), or else it may be integrated into the graphics card or the CPU. For moving images, this converter may be controlled to read from the buffer and provide signals to the monitor simultaneously with writing of image data to other parts of the buffer.

The memory buffer will comprise a conventional re-writable semiconductor memory device. Typically, the memory buffer comprises row and column decoders and buffers to enable reading from and writing to the memory.

The control of the decoders dictates the areas of the memory buffer to which access is provided. Each view has an associated pattern of memory cells to which access is provided. The memory device is conventional and will not be described in further detail.

The combined image memory buffer may form part of a graphics card together with the graphics accelerator. A depth buffer is also required, and as discussed below, a depth buffer may be required for each viewpoint, or else it is possible to share a depth buffer between the rendering operations.

The 3D data will generally be stored as a polygonal model data rather than in the form of two-dimensional images. The data corresponds to a 3D model containing objects which are typically broken down into groups of polygonal surfaces (primitives) in 3D object space. The data for each object in the model comprises a list giving the position and nature of every polygon that goes to make up the object, including the relative positions of its vertices and the colour or transparency of the polygon surface. In other systems, primitives may comprise curved surface patches, as is known in the art. It is known that a texture can be specified for mapping onto the surface, so that detail can be represented without increasing the number of primitives that make up the scene. A texture map is a stored 2-D array of texture element (texel) values defining a 2-D pattern of modulation that may for example define the colour of pixels, or may modulate other quantities such as reflectance or surface normal direction.

In order to generate views for display from the 3D model, graphics renderers (or accelerators) are used, as described above The invention is applicable to any graphics rendering process, for example conventional and screen space 3-D graphics renderers. A conventional renderer is one in which rendering primitives (typically triangles) are written sequentially to the video frame buffer and, as such, any pixel of the final image may be written at any time. A screen space renderer splits the screen into smaller areas of M×N pixels called tiles; this includes so-called scanline renderers where M is the width of the screen and N is 1 pixel. For each tile the screen space renderer determines which primitives contribute to (are overlapped by) that tile, performs rendering processes such as texturing, and writes pixel values for that tile to the frame buffer.

A conventional or screen space renderer can perform depth sorting for rendering primitives in each screen or tile using conventional z-buffer (depth buffer) methods. The z-buffer algorithm is used to deduce the nearest visible rendering primitive at each pixel and hence the colour of the pixel to be output. The screen space renderer need only maintain a z-buffer for each tile, whereas a conventional renderer must maintain a z-buffer for the screen.

If the combined image to be generated by the system of the invention is to be created on a primitive by primitive basis, this involves rendering the associated part of the 3D model for each view in turn, before rendering the next part of the 3D model (the next primitive). The different views would then each require separate depth buffers. If, instead, each view can be rendered completely before the next is started, then only one depth buffer would be required, which would be flushed between rendering of different views. Additional memory space would ideally be provided for storing vertices for the scene.

From reading the present disclosure, other modifications and variations will be apparent to persons skilled in the art. Such modifications and variations may involve equivalent features and other features which are already known in the art and which may be used instead of or in addition to features already disclosed herein.

While the matrix display panel in the above described embodiments comprises an LC display panel, it is envisaged that other kinds of electro-optical spatial light modulators and flat panel display devices, such as electroluminescent or plasma display panels, could be used.

1. An apparatus for controlling pixel addressing of a pixel display device to drive the display device as an N view autostereoscopic display, the apparatus comprising:
a graphics controller which generates multiple views of a scene from different viewpoints, the graphics controller comprising means for selectively accessing a combined image memory buffer, wherein each view is associated with a memory buffer access pattern, such that portions of each view are written by the graphics controller to allocated areas of the combined image memory buffer; and
a display driver for driving the display according to the data in the combined memory buffer.

2. An apparatus as claimed in claim 1, wherein the graphics controller further comprises one or more depth buffers.

3. An apparatus as claimed in claim 1, wherein the memory buffer comprises row and column decoders, the decoder settings defining the areas of the memory buffer to which access is provided.

4. An apparatus as claimed in claim 1, wherein the combined image memory buffer and the graphics controller are together provided on a graphics card.

5. An autostereoscopic display having an apparatus as claimed in claim 1 for controlling pixel addressing of a pixel display device to drive the display device as an N view autostereoscopic display.

6. A method of storing image data in a memory device, the image data comprising interleaved image data from a plurality of images of a 3D scene from different viewpoints, the method comprising:
(a) deriving an image of a 3D scene from a first viewpoint from a model of the 3D scene;
(b) storing portions of the derived image in a combined image memory buffer at locations derived from a memory buffer access pattern associated with the particular view;
(c) repeating steps (a) and (b) for additional viewpoints, until a complete interleaved image is stored in the combined memory buffer, and wherein a display is driven according to the data in the combined memory buffer.

7. A method as claimed in claim 6, wherein the display is driven according to the data in the combined memory buffer once the complete interleaved image is stored in the combined memory buffer.

8. A method as claimed in claim 6, wherein the display is driven according to the data in the combined memory buffer during writing to the combined memory buffer.
